(19) United States
(12) Patent Application Publication
(10) Pub. No.: US 2006/0069881 A1
(43) Pub. Date: Mar. 30, 2006

(54) Shared memory access control apparatus

(75) Inventor: Katsuya Sasahara, Izu-shi (JP)

Correspondence Address: FOLEY AND LARDNER LLP;SUITE 500, 3000 K STREET NW, WASHINGTON, DC, 20007, US

(73) Assignee: TOSHIBA TEC KABUSHIKI KAISHA

(21) Appl. No.: 11/008,123

(22) Filed: Dec. 10, 2004

(30) Foreign Application Priority Data
Sep. 28, 2004 (JP) 2004-281781

(51) Int. Cl. G06F 13/00

(52) U.S. Cl. 711/150; 711/151; 711/152

(57) ABSTRACT

A main CPU and a sub-CPU share a single port memory. In the single port memory in which a predetermined time has elapsed after the main CPU ends access to the single port memory, the sub-CPU sets a bus right of the single port memory to itself to access the single port memory, and the sub-CPU returns the bus right to the main CPU when the access is ended.

### CROSS-REFERENCE TO RELATED APPLICATIONS

This application is based upon and claims the benefit of priority from prior Japanese Patent Application No. 2004-281781, filed Sep. 28, 2004, the entire contents of which are incorporated herein by reference.

### BACKGROUND OF THE INVENTION

1. Field of the Invention

The present invention relates to a shared memory access control apparatus which can control a bus right, for example, when single port RAM (Random Access Memory) is shared by two controllers.

2. Description of the Related Art

MFP (Multi Function Peripheral) shown in FIG. 5 is well known. In MFP, paper in which an image is formed in an MFP main body 11 is discharged to a finisher 12 and a post-process such as stapling is performed in the finisher 12.

The MFP main body 11 and the finisher 12 include a control circuit shown by a block diagram of FIG. 3, and various pieces of data are transmitted and received by communication between the MFP main body 11 and the finisher 12.

As shown in FIG. 3, the MFP main body 11 and the finisher 12 are connected to each other through a serial communication line 13.

A shared memory 21 is provided in the MFP main body 11 and shared by a main CPU 22 and a sub-CPU 23.

A shared memory 24 is provided in the finisher 12 and shared by a main CPU 25 and a sub-CPU 26.

As shown in FIG. 4, the main CPU 22 performs a process of reading reception data stored in a half of a specific area (for example, 32 bytes in 64 bytes) in the shared memory 21 and writing transmission data in the remaining half (32 bytes) of the specific area at predetermined intervals (for example, 12 ms).

The sub-CPU 23 transmits the transmission data stored in the specific area of the shared memory 21 to the specific area of the shared memory 24 through the serial communication line 13 and the sub-CPU 26, and the sub-CPU 23 receives the transmission data transmitted from the shared memory 24 in the specific area of the shared memory 21 through the sub-CPU 23.

Thus, the conventional MFP performs the so-called mirroring, i.e. MFP makes the data stored in the specific area of the shared memory 21 provided in the MFP main body 11 equal to the data stored in the specific area of the shared memory 24 provided in the finisher 12.

In order to allow the main CPUs 22 and 25 and the sub-CPUs 23 and 26 to access, a dual port SRAM (Static Random Access Memory) is used as the shared memories 21 and 24.

A multiplex storage control apparatus, which can make a copy between external storage apparatuses without any trouble not by using the large-capacity RAM, is well known (Jpn. Pat. Appln. KOKAI Publication No. 2001-350595).

However, the dual port SRAM is an obstacle to cost reduction of MFP because the dual port SRAM is expensive when compared with the single port SRAM.

### BRIEF SUMMARY OF THE INVENTION

An object of the invention is to provide the shared memory access control apparatus which can achieve the cost reduction by using the single port SRAM.

According to an aspect of the invention, there is provided a shared memory access control apparatus comprising: a single port memory which is shared; a first controller which accesses the single port memory; and a second controller which accesses the single port memory, wherein the second controller comprises a count unit which is configured to count a predetermined time after the first controller accesses the single port memory, and a control unit which is configured to set a bus right to itself to access the single port memory when the count unit counts the predetermined time, and to return the bus right to the first controller when the access is ended.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a circuit diagram showing a configuration of a shared memory access control apparatus according to an embodiment of the invention;

FIG. 2 is a timing chart for explaining operation of the shared memory access control apparatus according to the embodiment;

FIG. 3 shows a system configuration including an MFP main body and a finisher according to the embodiment;

FIG. 4A is a timing chart showing a chip selection signal;

FIG. 4B is a timing chart showing a read signal;

FIG. 4C is a timing chart showing a write signal; and

FIG. 5 is an overall view of MFP.

### DETAILED DESCRIPTION OF THE INVENTION

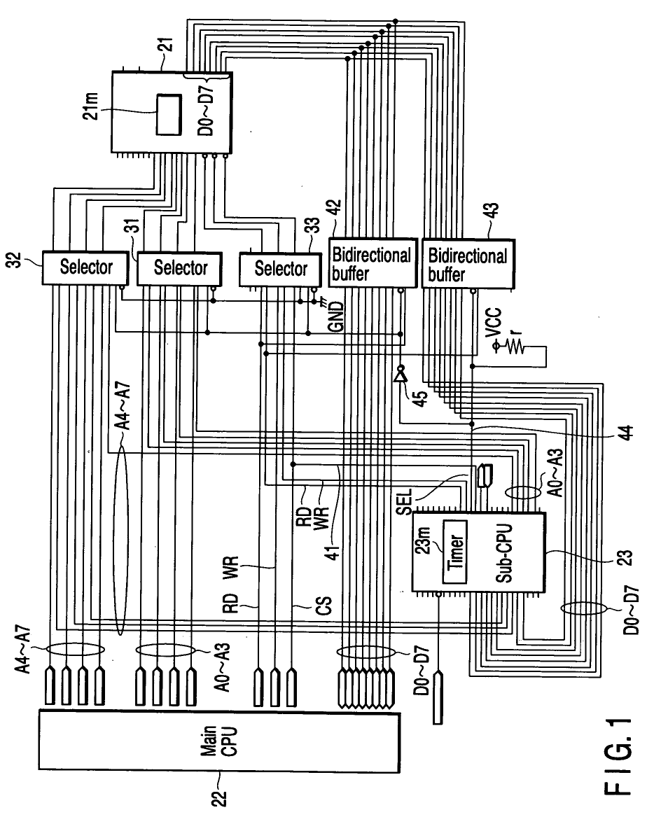

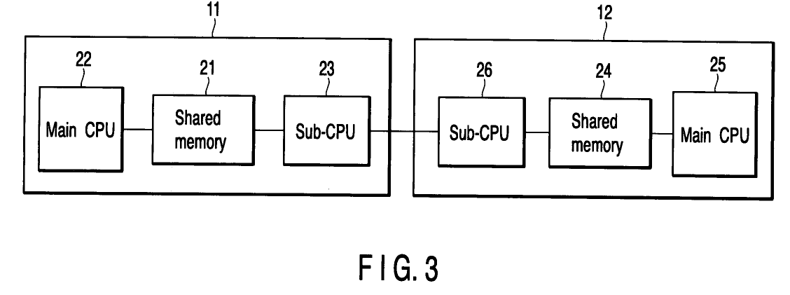

Referring now to the accompanying drawings, an embodiment of the invention will be described below. FIG. 1 is a detail circuit diagram in a MFP main body of FIG. 3. The shared memory 21 is formed by the single port SRAM.

In FIG. 1, address signals (A0 to A3) outputted from the main CPU (first controller) 22 are outputted to the shared memory 21 through a selector 31. Address signals (A4 to A7) outputted from the main CPU 22 are outputted to the shared memory 21 through a selector 32.

A read signal RD, a write signal WR, and a chip selection signal CS which are outputted from the main CPU 22 are outputted to the shared memory 21 through a selector 33. The chip selection signal CS is inputted to the sub-CPU (second controller) 23 through a line 41.

The read signal RD and the write signal WR which are outputted from the sub-CPU 23 are inputted to the selector 33.

Data signals (D0 to D7) outputted from the main CPU 22 are inputted to single ports (D0 to D7) of the shared memory 21 through a bidirectional buffer 42.

Further, the data signals (D0 to D7) outputted from the sub-CPU 23 are inputted to the single ports (D0 to D7) of the shared memory 21 through a bidirectional buffer 43.

The address signals (A0 to A3) outputted from the sub-CPU 23 are inputted to the selector 31.

The address signals (A4 to A7) outputted from the sub-CPU 23 are inputted to the selector 32.

A selection signal SEL outputted from the sub-CPU 23 is inputted to a gate G of the bidirectional buffer 43 through a line 44. When an L-level signal is inputted to the gate G, the gate is opened. Electric power Vcc (H level) is supplied to the line 44 through a pull-up resistor R.

The selection signal SEL outputted from the sub-CPU 23 is inputted to the gates G of the bidirectional buffer 42 and the selectors 31 to 33 through an inverter 45. When the L-level signal is inputted to the bidirectional buffer 42, the gate is opened.

The address signals (A0 to A7), the read signal RD, and the write signal WR which are outputted from the main CPU 22 are supplied to the shared memory 21, when the L-level signal is inputted to the gates G of the selector 31 to 33.

On the other hand, the address signals (A0 to A7), the read signal RD, and the write signal WR which are outputted from the sub-CPU 23 are supplied to the shared memory 21, when an H-level signal is inputted to the gates G of the selector 31 to 33.

The sub-CPU 23 also includes a timer 23m. The timer 23m is reset to start count operation at the time of a pulse rise of the chip selection signal CS inputted through the line 41. When the timer 23m counts a predetermined time, the selection signal SEL is switched to the L-level. The main CPU 22 accesses the 64 bytes in a specific area 21m of the shared memory 21 at a period of 12 ms. The predetermined time is set to a value sufficiently longer than the time (about 0.5 ms) taken for the main CPU 22 to access the 64 bytes in the specific area 21m, and the predetermined time is also set the value sufficiently shorter than the period of 12 ms. For example, the predetermined time is set to 1 to 5 ms. In the embodiment, the predetermined time is set to 1 ms.

Then, the operation of the embodiment of the invention having the above-described configuration will be described. Because the H-level signal is inputted to the line 44 through the pull-up resistor R in an initial state, the gate of the bidirectional buffer 43 is closed and the gate of the bidirectional buffer 42 is opened. Further, the address signals (A0 to A7), the read signal RD, and the write signal WR which are outputted from the main CPU 22 are supplied to the shared memory 21 through the selectors 31 to 33.

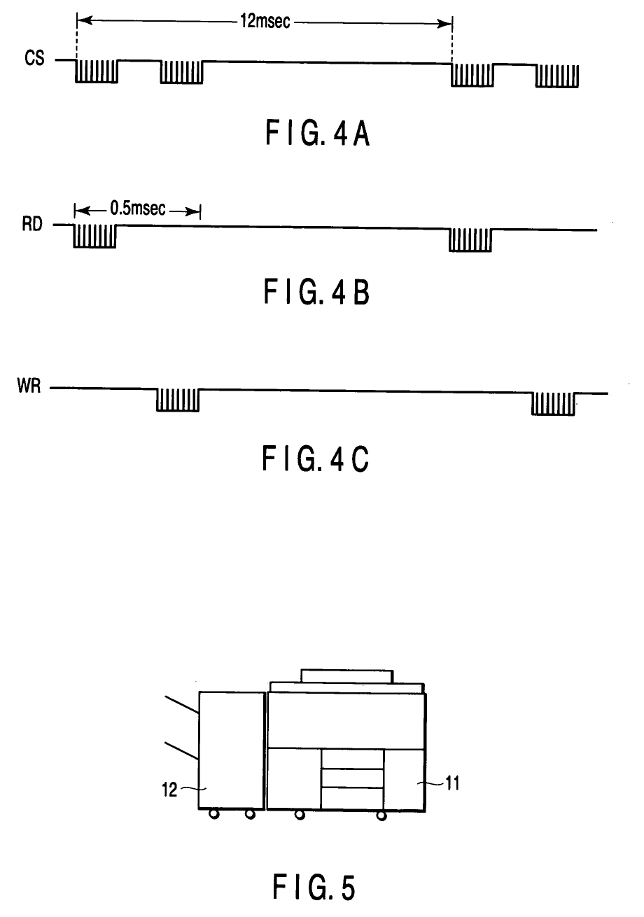

In the state of things, as shown in FIGS. 4A to 4C, the main CPU 22 reads the 32-byte data stored in the specific area 21m of the shared memory 21 at the period of 12 ms, and then the main CPU 22 writes the 32-byte data.

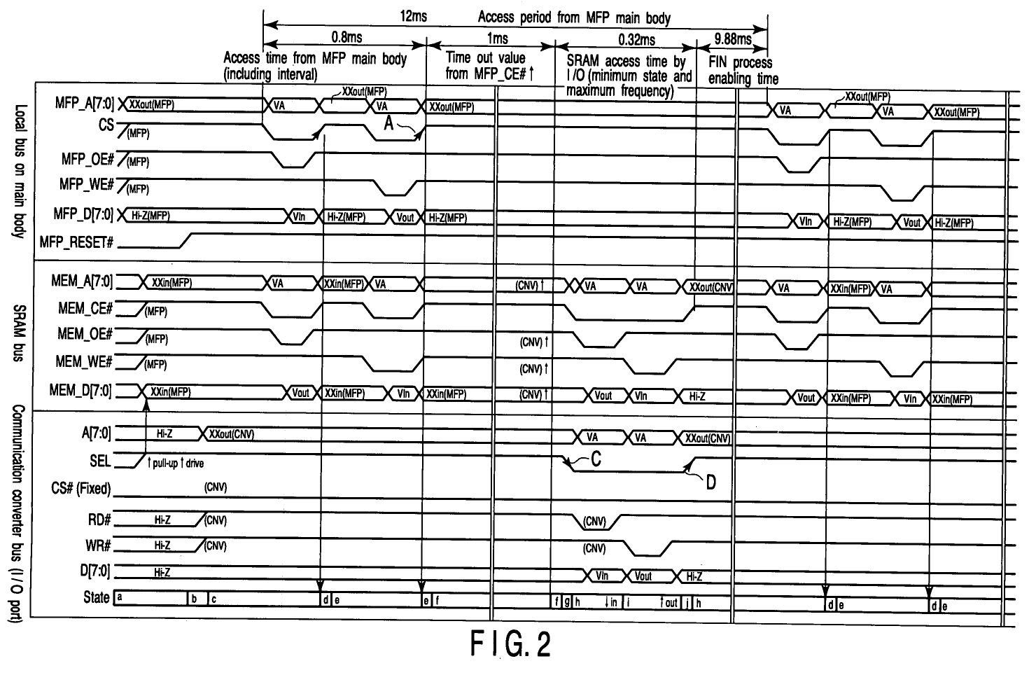

When the main CPU 22 accesses the shared memory 21, the chip selection signal CS outputted from the main CPU 22 pulsates as shown in FIG. 2. The main CPU 22 accesses the shared memory 21 after a pulse fall of the chip selection signal, and the main CPU 22 end the access to the shared memory 21 when the chip selection signal CS rises.

The chip selection signal CS rises periodically while the main CPU 22 accesses the shared memory 21, so that the timer 23m is reset before the predetermined is counted. Therefore, the selection signal SEL remains at the H-level.

However, when the timer 23m starts the count from timing (A in FIG. 2) of the pulse rise of the chip selection signal CS in which the main CPU 22 finally accesses the shared memory 21, the chip selection signal CS which resets the timer 23m is not inputted any more, so that the timer 23m continues the count operation. When the timer 23m counts the predetermined time, the timer 23m expires, so that the selection signal SEL is switched to the L-level (C in FIG. 2).

As a result, the gate of the bidirectional buffer 43 is opened, and the address signals (A0 to A7), the read signal RD, and the write signal WR which are outputted from the sub-CPU 23 are outputted to the shared memory 21 through the selectors 31 to 33.

Then, the sub-CPU 23 accesses the 64 bytes in the specific area 21m of the shared memory 21. When the sub-CPU 23 ends the access, the sub-CPU 23 switches the selection signal SEL to the H-level to return the bus right to the main CPU 22 (D in FIG. 2).

As described above, the sub-CPU 23 accesses the single port memory when the main CPU 22 does not access the single port memory and the sub-CPU 23 returns the bus right to the main CPU 22 when the sub-CPU 23 ends the access, so that the single port memory can be used as the shared memory 21. Therefore, the cost reduction can be realized.

In the embodiment, the control of the shared memory 21 in the MFP main body 11 is described. However, the invention can be also applied to the shared memory 24 in the finisher 12.

In the embodiment, the control of the shared memory 21 in the MFP main body 11 is described. However, the invention can be applied to other electronic apparatuses, and the shared memories mounted on the other electronic apparatuses can be realized by using the single port memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A shared memory access control apparatus comprising:
a single port memory which is shared;
a first controller which accesses the single port memory; and
a second controller which accesses the single port memory,
wherein the second controller comprises a count unit which is configured to count a predetermined time after the first controller accesses the single port memory, and
a control unit which is configured to set a bus right to itself to access the single port memory when the count unit counts the predetermined time, and to return the bus right to the first controller when the access is ended.

2. A shared memory access control apparatus according to claim 1, wherein the count unit is a timer which is reset at timing of a pulse rise of a chip selection signal to start count operation when the first controller accesses the single port memory.

3. A shared memory access control apparatus according to claim 1, wherein the predetermined time has a value sufficiently longer than a total time taken for the first controller to access the single port memory, and the predetermined time has the value sufficiently shorter than a period in which the first controller accesses the single port memory.

4. A shared memory access control apparatus comprising:
a single port memory which is shared;
a first controller which accesses the single port memory; and
a second controller which accesses the single port memory,
wherein the second controller comprises counting means for counting a predetermined time after the first controller accesses the single port memory, and
controlling means for setting a bus right to itself to access the single port memory when the count unit counts the predetermined time, and returning the bus right to the first controller when the access is ended.

5. A shared memory access control apparatus according to claim 4, wherein the counting means is a timer which is reset at timing of a pulse rise of a chip selection signal to start count operation when the first controller accesses the single port memory.

6. A shared memory access control apparatus according to claim 4, wherein the predetermined time has a value sufficiently longer than a total time taken for the first controller to access the single port memory, and the predetermined time has the value sufficiently shorter than a period in which the first controller accesses the single port memory.
